(19) United States
(12) Patent Application Publication
(10) Pub. No.: US 2012/0150632 A1
(43) Pub. Date: Jun. 14, 2012

(54) INTEGRATED CUSTOMER PREMISES EQUIPMENT TROUBLESHOOTING ASSISTANCE

(75) Inventors: James FAN, San Ramon, CA (US); Thomas BARRETT, San Ramon, CA (US); Jennifer K. LAM, Fremont, CA (US)

(73) Assignee: AT&T INTELLECTUAL PROPERTY I, L.P., Reno, NV (US)

(21) Appl. No.: 12/963,000

(22) Filed: Dec. 8, 2010

(51) Int. Cl. G06Q 10/00; G06Q 30/00

(52) U.S. Cl. 705/14.49; 705/304

(57) ABSTRACT

Providing troubleshooting information at a customer premises equipment device to be used with a service provided by a service provider includes storing operating instructions on a local storage of the customer premises equipment device. A search request is received, from a user of the customer premises equipment device, for operating instructions for resolving an issue related to the customer premises equipment device. A display screen displays a guided tutorial for implementing the operating instructions for resolving the issue. Assistance information, obtained by the service provider, is provided to the customer premises equipment device when implementing the operating instructions for resolving the issue does not resolve the issue.

### BACKGROUND

1. Field of the Disclosure

The present disclosure relates to troubleshooting issues for customer premises equipment. More particularly, the present disclosure relates to integrated customer premises equipment troubleshooting assistance.

2. Background Information

When a consumer electronic product is purchased (e.g., a television), a paper version of a user manual may be provided to a purchaser. The purchaser may turn on the television and use a menu key to navigate some basic setup options to connect an off-the-air digital antenna to a service provider network. However, operating information described in the paper version of the user manual may be inaccessible using a remote control. Further, when the purchaser reports an issue requiring troubleshooting assistance to a service provider agent or self-service system implemented by the service provider and the issue is determined to originate from the television, the customer sometimes has to call the television manufacturer to troubleshoot the issue.

### BRIEF DESCRIPTION OF THE DRAWINGS

FIG. 1 shows an exemplary general computer system that includes a set of instructions for implementing integrated customer premises equipment troubleshooting assistance;

FIG. 2 illustrates a system diagram of an integrated customer premise equipment, according to an aspect of the present disclosure;

FIG. 3A illustrates a system diagram including an integrated customer premises equipment connected to the Internet, according to an aspect of the present disclosure;

FIG. 3B illustrates a system diagram that indicates contact among a customer premises equipment vendor, a service provider and an integrated customer premises equipment, according to an aspect of the present disclosure;

FIG. 4 illustrates an process flow diagram for establishing and using a troubleshooting assistance service channel, according to an aspect of the present disclosure; and

FIG. 5 illustrates an exemplary process flow diagram for providing value-added services to the customer premises equipment, according to an aspect of the present disclosure.

### DETAILED DESCRIPTION

In view of the foregoing, the present disclosure, through one or more of its various aspects, embodiments and/or specific features or sub-components, is thus intended to bring out one or more of the advantages as specifically noted below.

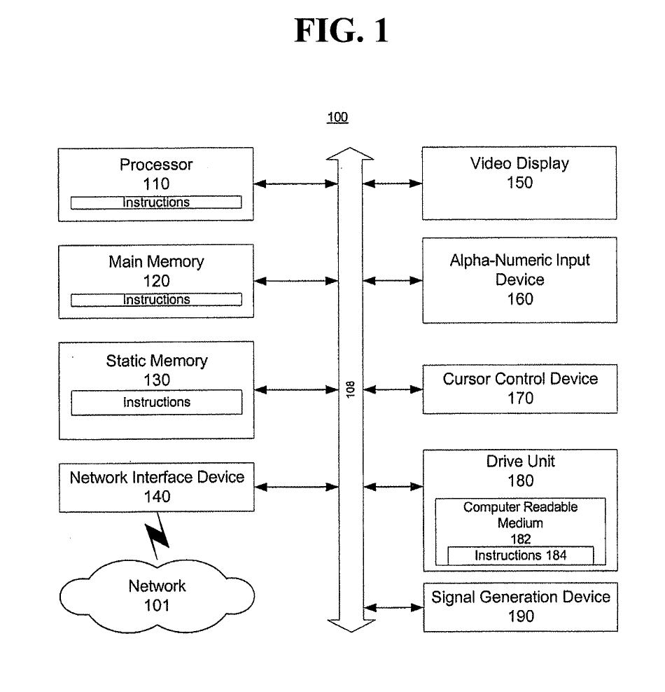

FIG. 1 is an illustrative embodiment of a general computer system, on which a method to provide integrated customer premises service equipment troubleshooting assistance can be implemented, which is shown and is designated 100. The computer system 100 can include a set of instructions that can be executed to cause the computer system 100 to perform any one or more of the methods or computer based functions disclosed herein. The computer system 100 may operate as a standalone device or may be connected, for example, using a network 101, to other computer systems or peripheral devices.

In a networked deployment, the computer system may operate in the capacity of a server or as a client user computer in a server-client user network environment, or as a peer computer system in a peer-to-peer (or distributed) network environment. The computer system 100 can also be implemented as or incorporated into various devices, such as a personal computer (PC), a tablet PC, a set-top box (STB), a personal digital assistant (PDA), a mobile device, a global positioning satellite (GPS) device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 100 can be implemented using electronic devices that provide voice, video or data communication. Further, while a single computer system 100 is illustrated, the term “system” shall also be taken to include any collection of systems or sub-systems that individually or jointly execute a set, or multiple sets, of instructions to perform one or more computer functions.

As illustrated in FIG. 1, the computer system 100 may include a processor 110, for example, a central processing unit (CPU), a graphics processing unit (GPU), or both. Moreover, the computer system 100 can include a main memory 120 and a static memory 130 that can communicate with each other via a bus 108. As shown, the computer system 100 may further include a video display unit 150, such as a liquid crystal display (LCD), an organic light emitting diode (OLED), a flat panel display, a solid state display, or a cathode ray tube (CRT). Additionally, the computer system 100 may include an input device 160, such as a keyboard, and a cursor control device 170, such as a mouse. The computer system 100 can also include a disk drive unit 180, a signal generation device 190, such as a speaker or remote control, and a network interface device 140.

In a particular embodiment, as depicted in FIG. 1, the disk drive unit 180 may include a computer-readable medium 182 in which one or more sets of instructions 184, e.g. software, can be embedded. A computer-readable medium 182 is a tangible article of manufacture, from which sets of instructions 184 can be read. Further, the instructions 184 may embody one or more of the methods or logic as described herein. In a particular embodiment, the instructions 184 may reside completely, or at least partially, within the main memory 120, the static memory 130, and/or within the processor 110 during execution by the computer system 100. The main memory 120 and the processor 110 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium 182 that includes instructions 184 or receives and executes instructions 184 responsive to a propagated signal, so that a device connected to a network 101 can communicate voice, video or data over the network 101. Further, the instructions 184 may be transmitted or received over the network 101 via the network interface device 140.

According to an aspect of the present disclosure, service providers may offer bundled services to attract new customers or retain existing customers. When product offerings are bundled, the service provider's organization must support numerous troubleshooting inquiries regarding any combination of the bundled services. Insofar as the product offerings are bundled by the service providers, troubleshooting assistance domains associated with each of the products are within the service providers' control. However, bundled products may be implemented on non-standard customer premises equipment that a customer purchases from a source different from the service provider. Customers may expect to plug a customer premises equipment into a home network and begin consuming the bundled services. However, troubleshooting issues arise when the customer premises equipment is not compatible with the bundled services, or is not functioning properly.

For example, if a solution to a troubleshooting issue is to purchase additional accessories for the customer premises equipment (e.g., a television), the customer must independently obtain information regarding compatible customer premise equipment that uses the service provider's services. Alternatively, the customer must independently obtain a recommendation for a customer premise equipment repair facility. Further, if there is a recall from a customer premises equipment manufacturer and if the customer is not registered to receive this information, the manufacturer may not be able to locate the customer in order to send necessary recall information.

According to another non-limiting embodiment of the present disclosure, content of a paper version of a user manual is incorporated into a customer premises equipment storage area such that guided tutorials are supported for selected setup and troubleshooting procedures. That is, guided tutorials and a customer premises equipment user manual are accessible without a network connection (e.g., before the customer premises equipment is connected to a service provider's network).

According to yet another non-limiting embodiment of the present disclosure, an integrated customer premise equipment troubleshooting assistance and service network troubleshooting assistance supports an assisted and a self-service troubleshooting model.

According to a non-limiting embodiment of the present disclosure, valued added services are providable by recommending optimal customer premises equipment accessories and customer premises equipment repair facilities (e.g., via Yellow Pages™). Accordingly, dynamic advertising capabilities are providable.

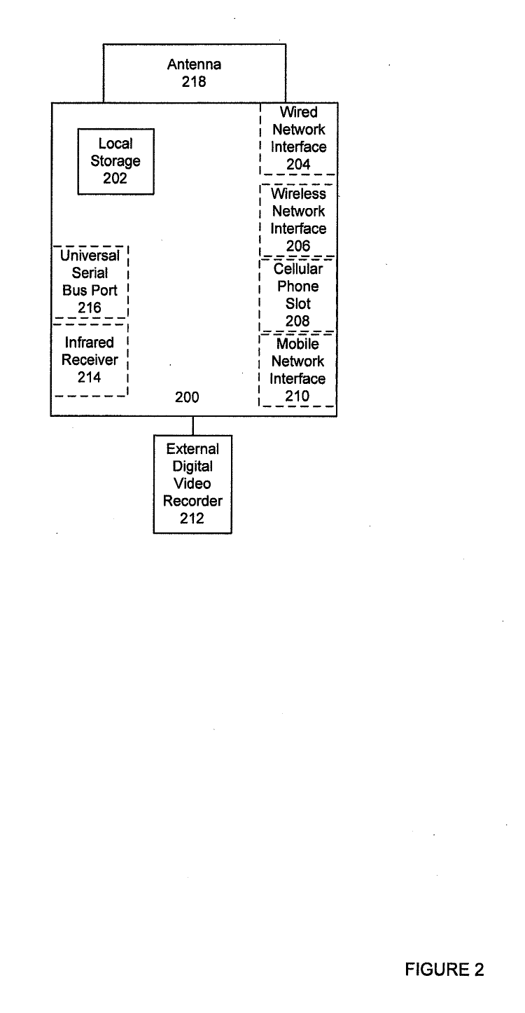

In FIG. 2, a system diagram of an integrated customer premises equipment according to the present disclosure is shown. A customer premises equipment 200 includes a local storage 202. The customer premises equipment 200 is, for example, a next-generation digital television. The local storage 202 is, for example a resident flash memory that stores user manual information that relates to operating the customer premises equipment. A search tool software, implemented on the local storage 202, or any other storage space in the customer premises equipment 200, is used to locate information for a user configuring the customer premises equipment 200. In one non-limiting embodiment of the present disclosure, the information is located prior to, or concurrently with establishing either antenna or cable television connections. In another non-limiting embodiment of the present disclosure, the customer premises equipment 200 includes a wired network interface 204 and a wireless network interface 206 that enable the customer premises equipment to connect to either or both a wired data network and wireless data network. If a wireless or wired connection is established, user manual information stored in the local storage 202 is automatically updated, to ensure that user manual information stored in the local storage 202 shipped with the customer premises equipment does not become outdated. The local storage 202 of the customer premises equipment 200 stores device metadata, as well as preloaded diagnostic tools, the user manual and graphical, guided user tutorials.

In another non-limiting embodiment of the present disclosure, the customer premises equipment 200 does not access the wired or wireless data network and does not have user manual information stored in the local storage 202. A physical slot for a cellular phone 208 and a mobile network (e.g., Bluetooth™) interface 210 in the customer premises equipment 200 establish mobile telecommunications network connectivity. For example, a MiFi™ enabled cellular phone acts as a gateway to allow a wireless-enabled customer premises equipment to establish a tethering connection, such that Internet connectivity is achieved wirelessly.

In yet another non-limiting embodiment of the present disclosure, an external digital video recorder 212 (DVR) stores a subset of user manuals and diagnostic tools provided by the service provider. In one non-limiting embodiment of the present disclosure, the customer premises equipment 200 is pre-configured to access a customer premise equipment vendor's website to automatically register the customer and the customer premises equipment, as well to receive manual updates to the user manual information. For example, a customer's television may receive an update when it is connected to a service provider's cable television broadcasting platform.

The customer premises equipment 200 also includes an infrared receiver 214 through which remote control signals are received, a universal serial bus (USB) port 216 that accommodates a flash drive, and an antenna 218 that receives over-the-air programming.

In one non-limiting embodiment of the present disclosure, the metadata is stored in both a local digital video recorder as well as in a remote, service provider database. The metadata allows the service provider to determine whether a current version of the customer premises manual information is stored, and if not, the service provider launches a data retrieval request to fetch customer premises manual information from a website for a vendor or manufacturer of the customer premises equipment. Accordingly, the service provider stores an integrated package to support the customer and in another non-limiting embodiment of the present disclosure, a subset of the integrated package is transmitted, or “pushed” to either the local storage 202 or the digital video recorder 212 (i.e., as a backup in the event that the digital video recorder loses network connectivity).

When the customer premises equipment 200 uses the antenna 218 to receive off-the-air broadcasting, the user manual information directs the user to perform the appropriate setup operations in order to receive the off-the-air broadcasting. If the customer premises equipment 200 is not successfully connected to the service provider's network or the connection to the service provider is interrupted due to an issue with the customer premises equipment 200, graphical, guided video tutorials stored on the local storage 202 are displayed for the user. In one non-limiting embodiment of the present disclosure, the guided tutorials are interactive video clips.

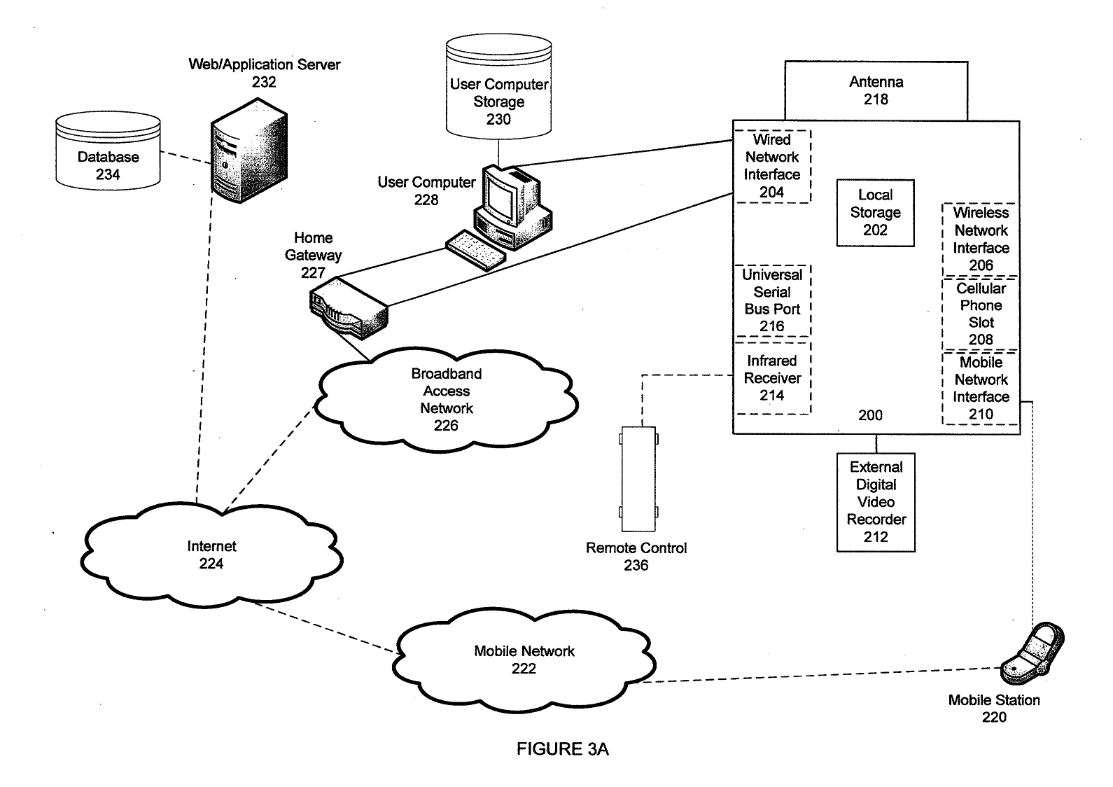

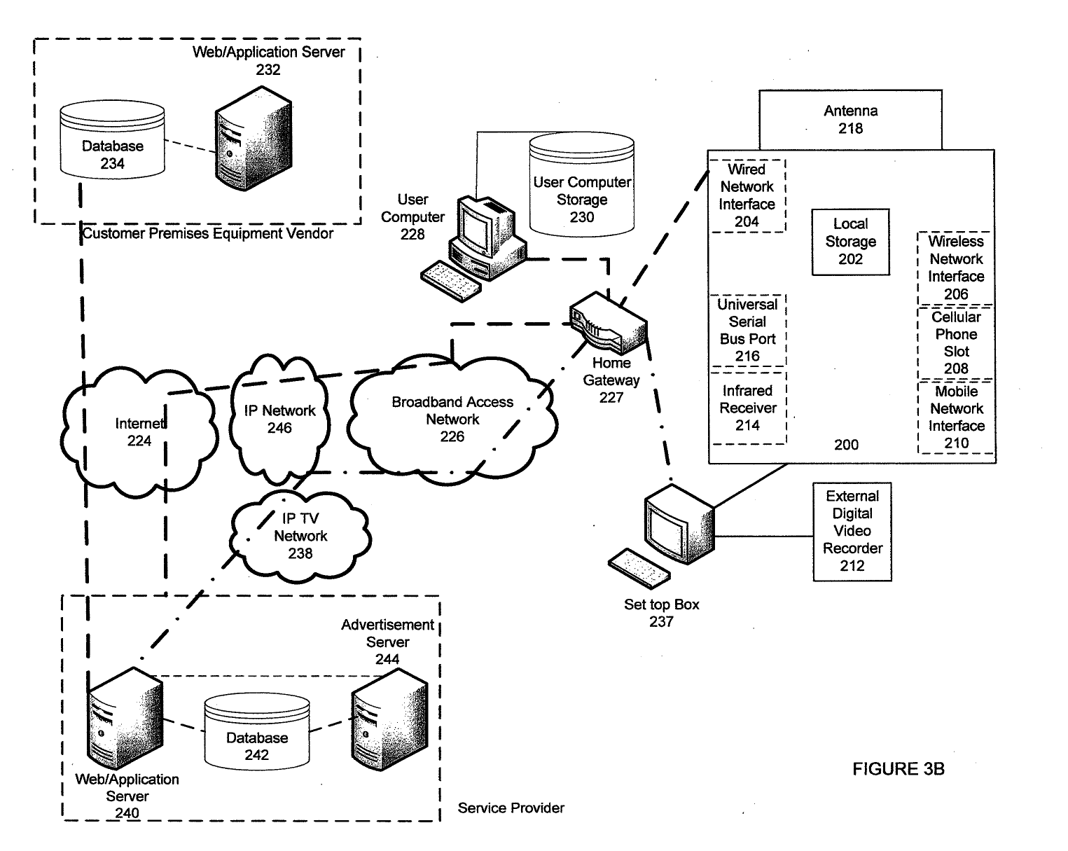

In FIG. 3A, a system diagram including an integrated customer premises equipment connected to the Internet is shown. The customer premises equipment 200 connects to Internet 224 via any of the following, but not limited to: via the mobile network interface 210 and a mobile station 220 that communicates over the mobile network 222; via the wired network interface 204 and a user computer 228 with user computer storage 230 that connects to a home gateway 227 and that communicates over a broadband access network 226; and via (not shown) the wireless network interface 206 and the user computer 228 that communicates over the broadband access network 226. In one non-limiting embodiment of the present disclosure, the wired network interface 204 directly connects to the home gateway 227. In the illustrated manner, the customer premises equipment 200 connects to a web/application server 232 and a database 234. In one non-limiting embodiment of the present disclosure, the web/application server 232 and the database 234 are maintained by the service provider. In another non-limiting embodiment of the present disclosure, the web/application server 232 and the database 234 are maintained by a vendor or a manufacturer of the customer premises equipment 200. The infrared receiver 214 receives signals from remote control 236.

In FIG. 3B, communication among the customer premises equipment vendor, the service provider and the integrated customer premises equipment is shown. The user can communicate via the customer premises equipment 200 and a Set top Box 237, which is connected to an external digital video recorder 212. In one non-limiting embodiment of the present disclosure, the digital video recorder is internal to the customer premises equipment 200. When the user connects to the service provider via the Set top Box 237 (shown as a dashed and dotted line) and the home gateway 227, data flows through a broadband access network 226, IP Network 246 and optionally, an IPTV service network 238. In another non-limiting embodiment of the present disclosure, the wired network interface 204 directly connects to the home gateway 227. In FIG. 3B, the user is shown as connecting to a web/application server 240 of the service provider. The service provider is shown, in FIG. 3B, as including a database 242 and an advertisement server 244. In another non-limiting embodiment of the present disclosure, the user connects to either the database 242 or the advertisement server 244. The database 242 stores any of the following, but not limited to: the customer records, an updated user manual, recall information, troubleshooting information, advertisements and Yellow Pages™ information. The web/application server 240 provides access to the stored items. The advertisement server 244 stores advertisements for one or more of the service provider, the customer premises equipment vendor and the manufacturer of the customer premises equipment. Accordingly, the user is enabled to access the customer records, an updated user manual, recall information, troubleshooting information, advertisements and Yellow Pages™ information via a television connection.

When the user connects to the service provider via the user computer 228 (shown as a dashed line) and the home gateway 227, data flows through the broadband access network 226, the IP network 246 and the Internet 224 to the service provider. As discussed above, the user is shown as connecting to the web/application server 240 of the service provider, but can additionally or alternatively connect to one or both of the database 242 and the advertisement server 244. In this manner, the user is able to obtain the customer records, an updated user manual, troubleshooting information, recall information, advertisements and Yellow Pages™ information via an Internet connection.

The service provider, in turn, obtains any of the following, but not limited to: user manual updates, troubleshooting information, recall information and advertisements from the customer premises equipment vendor. In one non-limiting embodiment of the present disclosure, the database 234 stores user manual updates, recall information, troubleshooting information and advertisements for the customer premises equipment vendor. In another non-limiting embodiment of the present disclosure, the customer premises equipment vendor is replaced with a manufacturer of the customer premises equipment. While web/application server 240 is shown as directly connecting to customer premises equipment vendor database 234, the service provider may alternatively or additionally connect to the web/application server 232. As shown in FIGS. 3A and 3B and described herein, the user can directly connect to one or more of the service provider, the manufacturer of the customer premises equipment device and the vendor of the customer premises equipment device. Alternatively, the user can directly connect to the service provider, and indirectly connect to either or both the manufacturer of the customer premises equipment device and the vendor of the customer premises equipment device.

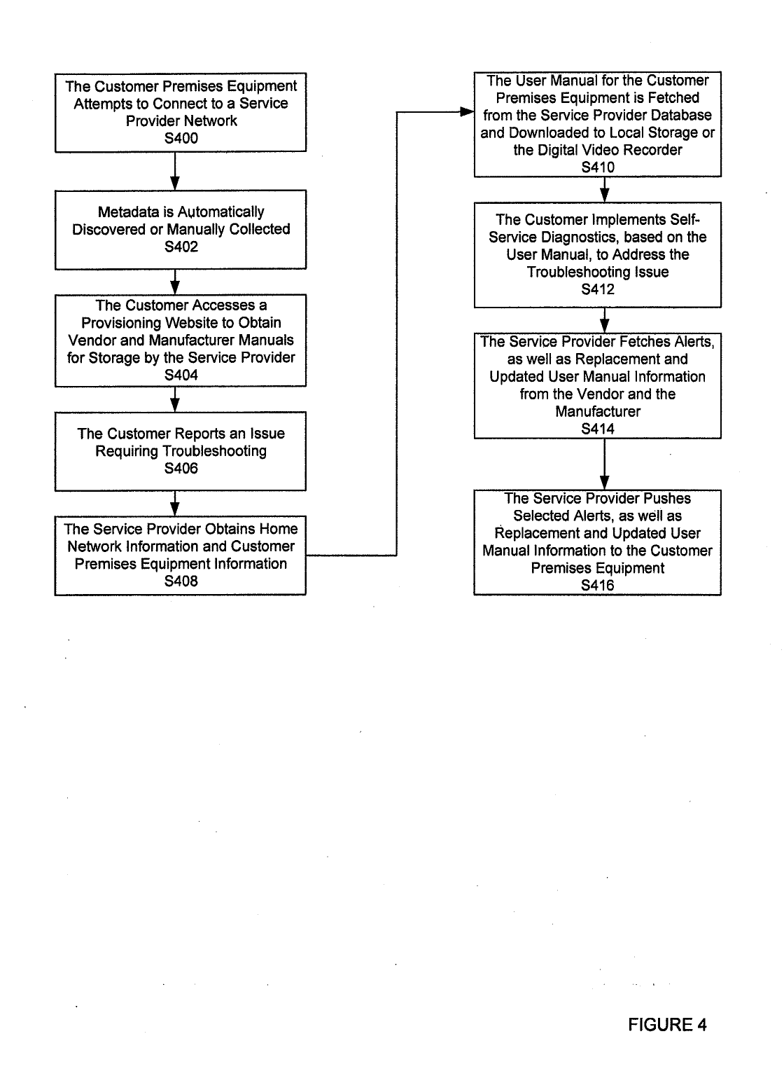

In FIG. 4, a process flow diagram according an aspect of the present disclosure is shown. In step S400, the customer premises equipment attempts to connect to a service provider network. In step S402, when a network connection is established between the customer premises equipment and the service provider, metadata for the customer premises equipment is attempted to be discovered by the servicer provider's connecting devices (e.g., via a set-top box or a remote server). If the metadata is not automatically discoverable, the user is prompted to select customer premises information related to any of the following, but not limited to: a manufacturer, model, year, serial number, place of purchase, purchase date, cost, a warranty and remote control information. In one non-limiting embodiment of the present disclosure, the service provider coordinates with the customer premises equipment manufacturer to minimize data input requirements. For example, a menu driven user interface that needs minimal input may be set to automatically obtain additional, associated data attributes for the customer premises equipment. Alternatively, a computer accesses the Internet to provide the service provider with metadata for the customer premises equipment.

Accordingly, a troubleshooting assistance service channel is automatically established. When the customer decides to initiate troubleshooting, it is transparent as to whether customer premises equipment manual information is obtained from the local storage (e.g., a digital video recorder) or from a service provider database. In this manner, network diagnostics and local diagnostics are fully integrated.

In step S404, the customer optionally accesses a provisioning website (e.g., using a cell phone or a computer) that is maintained by the service provider. In one non-limiting embodiment of the present disclosure, the customer is prompted to enter same information described with respect to step S402. Alternatively, a technician enters this information for the concurrently with installing the customer premises equipment. The provisioning website searches the Internet, either in real-time or a priori, to obtain vendor user manuals, manufacturer user manuals, remote control and contact information for the customer premises equipment, and saves the customer premises equipment information to a record related to the customer. In one non-limiting embodiment of the present disclosure, the user manuals are saved in a shared service provider database, by the service provider. In another non-limiting embodiment of the present disclosure, the user manual information is stored such that it is searchable by keywords, phrases and other logical constructs.

In step S406, the customer reports an issue that requires troubleshooting. In step S408, the service provider's “service assurance applications” obtain home network information in addition to customer premises equipment information. If it is determined that the issue is solely related to the customer premises equipment, a service provider diagnostic function fetches, in step S410, the user manual for the customer premises equipment. If the customer premises equipment is a television set, a copy of the user manual is downloaded from the service provider database to a local storage or a digital video recorder that is attached to or inside a set-top box for the customer premises equipment. In one non-limiting embodiment of the present disclosure, the user manual is indexed and searchable. In another non-limiting embodiment of the present disclosure, a micro-expert software that enables keyword and phrase searching is also downloaded.

In step S412, the customer continues to implement self-service diagnostics to address the issue requiring the troubleshooting, based on the downloaded or locally stored user manual information. In step S414, at a configurable period (e.g., weekly, monthly or yearly), the service provider fetches information from the vendor's or the manufacturer's website or other accessible storage to obtain a latest version of the user manual, updated alerts and part replacement information, and compares the fetched data to the information stored in the service provider database. In one non-limiting embodiment, if there is a recall alert, the service provider sends relevant information to the service provider's service department, such that installation, network, operation and other agents are aware of the defective customer premises equipment. In step S416, the recall and/or alert information is incorporated in a diagnostic system and pushed to the customer premises equipment.

In another non-limiting embodiment of the present disclosure, the customer premise equipment manufacturer or vendor sends alerts (e.g., recall information) to relevant users by contacting the service provider to push the alert information to the service provider's website and set-top box. The service provider is able to access the appropriate set-top boxes because the service provider stores user information. For example, if there is a recall for the model of customer premises equipment that the customer is having issues with, the recall information is pushed to the television with targeted advertisements to replace a current model of television with a newer model of the television, along with a discount of purchasing the newer model of the television. As yet another example, a rating for the television (e.g., a Consumer Report™ that rates the television and similar types of televisions) is also displayed for the customer.

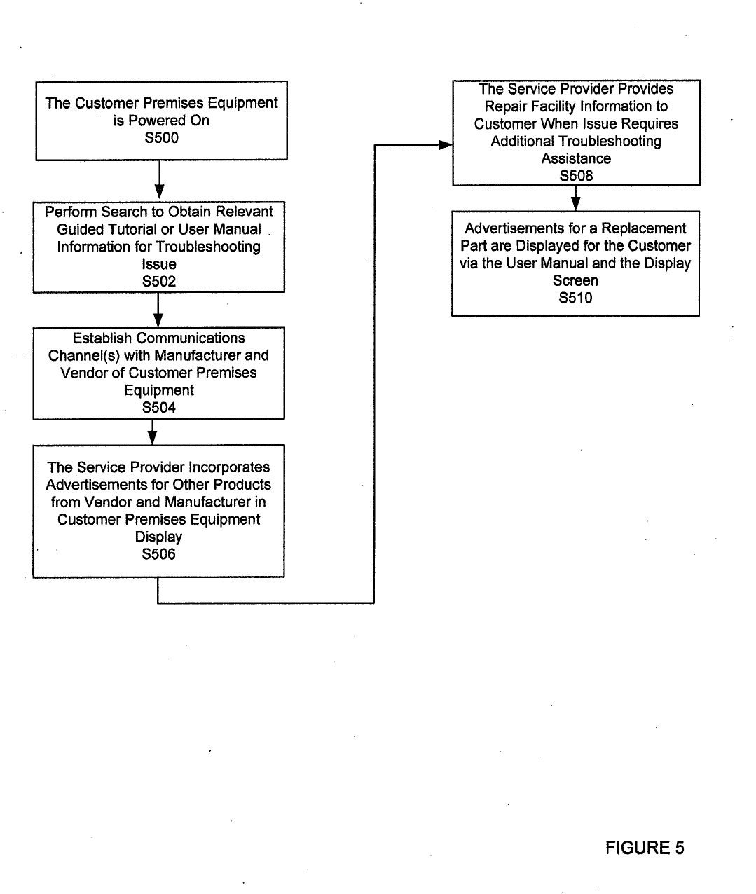

In FIG. 5, is an exemplary process flow diagram for providing value-added services to the customer premises equipment. In step S500, the customer powers on the customer premises equipment device, e.g., a television that is to be used with, for example, a cable service. During step S500, the customer may observe, for example, problems with the clarity of the screen display. The process proceeds to step S502, in which the customer navigates to perform a keyword or phrase search of locally stored user manual information or guided tutorials for fixing the clarity of the screen display using, for example, an attendant remote control as an input device. Alternatively, a data-enabled cellular phone with a television remote application or add-on unit is usable as a remote control.

As yet another alternative, the customer navigates, via the television, a cellular phone or a computer to the service provider's website to search for the same information, insofar as the user manual and customer information is also stored in a customer record in the service provider database. Upon customer logon, device information for the television is provided, including the user manual. Accordingly, the user can search for resolutions to the specified problem using the device information and/or the user manual information provided by the service priority.

During the troubleshooting process, the customer may add notes to descriptions of issues that are stored with the customer's record in the service provider's database. Accordingly, the customer can track their troubleshooting resolution history. In another non-limiting embodiment of the present disclosure, the customers collaboratively share their troubleshooting experiences (e.g., stored notes) via a service provider blog or a community services website.

In one non-limiting embodiment, a service provider optionally determines which type of customer premises equipment are most popular in step S504, and develops a partnership, i.e., establishes a communication channel, with the manufacturer or the vendor of the customer premises equipment to implement joint troubleshooting assistance. The manufacturer provides, for example, information regarding technical support contact information and local technical repair facility information to the service provider. In step S506, the service provider incorporates advertisements for the latest television models of the manufacturer in the user manual, so that when user accesses the user manual, advertisements for the latest television models are presented on the user's television screen. In one non-limiting embodiment, the service provider collects fees from the manufacturer based on a number of times advertisements are displayed to the user, or based on a flat fee arrangement.

In step S508, it is determined that the customer is unable to address the issue requiring troubleshooting (e.g., fixing screen clarity) without additional assistance from an outside source. The service provider contacts local repair facilities and displays relevant information to the user. For example, the service provider uses the user's location to obtain a nearby location for a television repair facility that is enabled to fix the user's model of television. In one non-limiting embodiment of the present disclosure, the service provider displays hours for the repair facility and average cost of repair, along with contact information and geographic information for the repair facility. In step S510, when the user views the user manual (e.g., on the television or online), any of the following products, but not limited to: a newer model of the customer premises equipment and accessories for the customer premises equipment are advertised. For example, the service provider or other entity may determine that the user needs new accessories, such a new screen cover and a new digital antenna. In one non-limiting embodiment of the present disclosure, the customer premises equipment has a problem with the display screen because an antenna for the television is not functioning properly. Accordingly, when it is determined that the user needs to buy a new antenna, radio buttons and popup advertisements are displayed for the user (e.g., when the user is performing a search of the user manual).

As another example, when the customer encounters the display screen clarity issue as noted above, a number of troubleshooting options may be available. For example, one solution includes purchasing an additional filter device from the service provider's partner. Another solution is includes dealing with a lower quality, but tolerable signal strength. The targeted advertisement displayed in step S510 explains, in one non-limiting embodiment of the present disclosure, advantages of the first solution, for the customer.

In view of the above, an end-to-end service model is established for a service provider to serve their customers, including troubleshooting issues directly related to a customer premises equipment device. This is in contrast to service providers that typically do not provide support services for customer premises equipment (i.e., because customer premises equipment is not always purchased from a service provider). Enhanced service opportunities and increased customer satisfaction results from eliminating the necessity of contacting a customer premises equipment manufacturer and reducing troubleshooting contacts to tier 1 or tier 2 service agents.

Service providers also have additional revenue streams insofar as service functions are integrated with relevant product information. Specifically, a service provider can charge additional fees for providing troubleshooting support for various customer premises equipment, similar to an “inside wire” fee. Further, additional revenue streams are realized by enabling access to, for example, Yellow Pages™ and providing targeted advertisements.

Accordingly, the present invention enables a user to store operating instructions on a local storage of a customer premises equipment device, receiving a search request, from a user of the customer premises equipment device, for operating instructions for resolving an issue related to the customer premises equipment device and display, on a display screen of the customer premises equipment device, a guided tutorial for implementing the operating instructions for resolving the issue. Assistance information, obtained by the service provider, is provided to the customer premises equipment device when implementing the operating instructions for resolving the issue does not resolve the issue.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present specification describes components and functions that may be implemented in particular embodiments with reference to particular standards and protocols, the disclosure is not limited to such standards and protocols. For example, standards for Internet and other packed switched network transmission as well as voice over Internet protocol represent examples of the state of the art. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for providing troubleshooting information at a customer premises equipment device to be used with a service provided by a service provider, comprising:
storing operating instructions on a local storage of the customer premises equipment device;
receiving a search request, from a user of the customer premises equipment device, for operating instructions for resolving an issue related to the customer premises equipment device;
displaying, on a display screen of the customer premises equipment device, a guided tutorial for implementing the operating instructions for resolving the issue,
wherein assistance information, obtained by the service provider, is provided to the customer premises equipment device when implementing the operating instructions for resolving the issue does not resolve the issue.

2. The method according to claim 1, further comprising:
establishing a network connection between the customer premises equipment device and the service provider.

3. The method according to claim 2,
wherein the network connection is distinct from a network connection established over a service network maintained by the service provider.

4. The method according to claim 2,
wherein the network connection is a data network connection established over a data network.

5. The method according to claim 2,
wherein the network connection is a telecommunications network connection established over a telecommunications network.

6. The method according to claim 1, further comprising;
obtaining, by the service provider, metadata for the customer premise equipment device.

7. The method according to claim 1,
wherein the assistance information includes updated operating instructions obtained from a manufacturer of the customer premises equipment device.

8. The method according to claim 1,
wherein the service provider obtains the assistance information in real-time.

9. The method according to claim 1,
wherein the assistance information includes repair facility information for repairing the customer premise equipment device.

10. The method according to claim 1,
wherein the service provider pushes the assistance information to the local storage.

11. The method according to claim 1,
wherein the assistance information includes advertisement information for purchasing accessories for the customer premises equipment device.

12. The method according to claim 1,
wherein the assistance information includes advertisement information for purchasing a newer model of the customer premises equipment device.

13. The system according to claim 12, further comprising:
charging a fee each time the advertisement information is displayed.

14. The system according to claim 1, further comprising:
pushing recall information, obtained by the service provider, to the local storage.

15. A non-transitory, tangible computer readable medium that includes a set of instructions for providing troubleshooting information at a customer premises equipment device to be used with a service provided by a service provider, the set of instructions directing at least one processor to perform acts of:
storing operating instructions on a local storage of the customer premises equipment device;
receiving a search request, from a user of the customer premises equipment device, for operating instructions for resolving an issue related to the customer premises equipment device;
displaying, on a display screen of the customer premises equipment device, a guided tutorial for implementing the operating instructions for resolving the issue,
wherein assistance information, obtained by the service provider, is provided to the customer premises equipment device when implementing the operating instructions for resolving the issue does not resolve the issue.

16. The tangible computer readable medium according to claim 15,
wherein the guided tutorials are interactive.

17. The tangible computer readable medium according to claim 15,
wherein the local storage is a digital video recorder.

18. The tangible computer readable medium according to claim 15,
wherein the service provider stores updated operating instructions and a record corresponding to the customer premises equipment and the user.

19. The tangible computer readable medium according to claim 18,
wherein the record is annotated with notes for resolving the issue related to the customer premises equipment.

20. A system for providing troubleshooting information at a customer premises equipment device to be used with a service provided by a service provider, comprising:
a local storage of the customer premises equipment device that stores operating instructions that are searchable, by a user of the customer premises equipment device, for operating instructions for resolving an issue related to the customer premises equipment device;
a display screen of the customer premises equipment device that displays a guided tutorial for implementing the operating instructions for resolving the issue; and
an interface of the customer premises equipment device that receives assistance information, obtained by the service provider, when implementing the operating instructions for resolving the issue does not resolve the issue.
